(19) United States
(12) Patent Application Publication
(10) Pub. No.: US 2024/0039722 A1
(43) Pub. Date: Feb. 1, 2024

(54) DYNAMIC UTILIZATION OF A NON-FUNGIBLE TOKEN (NFT) AS A USER IDENTIFIER BASED ON CONTEXT

(71) Applicant: Unstoppable Domains, Inc., Las Vegas, NV (US)

(72) Inventor: Lisa Seacat DeLuca, Bozeman, MT (US)

(21) Appl. No.: 17/877,095

(22) Filed: Jul. 29, 2022

(51) Int. Cl. H04L 9/32; H04L 67/306

(52) U.S. Cl. CPC H04L 9/3213; H04L 67/306

(57) ABSTRACT

According to a present invention embodiment, a system for utilizing different user identifiers for performing activities of applications based on activity context comprises one or more memories and at least one processor coupled to the one or more memories. The system determines context information for an activity of an application performed by a user. A non-fungible token of the user is identified with one or more attributes corresponding to the context information. The application is directed to use the identified non-fungible token as a user identifier for performing the activity. Embodiments of the present invention further include a method and computer program product for utilizing different user identifiers for performing activities of applications based on activity context in substantially the same manner described above.

### BACKGROUND

### 1. Technical Field

Present invention embodiments relate to security for electronic communications, and more specifically, to dynamically selecting and utilizing a non-fungible token (NFT) of a user as a user identifier (e.g., profile picture (PFP), etc.) for an activity based on context of the activity.

### 2. Discussion of the Related Art

A profile picture (PFP) for a user is typically associated with social media and online identity accounts. A non-fungible token (NFT) is a crypto type asset with each token being unique (and representing items, such as digital art, music, or video game items), whereas fungible tokens (e.g., coins of the same cryptocurrency) have the same value of worth and are exchangeable. Non-fungible tokens (NFTs) for use as profile pictures (PFPs) (or profile picture non-fungible tokens (PFP NFTs)) are growing in popularity. By having a non-fungible token (NFT) as a profile picture (PFP), a user can show their digitally scarce asset (e.g., digital art, etc.). A profile picture non-fungible token (PFP NFT) is associated with a crypto wallet having an address that proves user ownership. However, often times a user collects multiple non-fungible tokens (NFTs) which leads to more than one non-fungible token (NFT) in their collection that may be used as a profile picture (PFP).

### SUMMARY

According to one embodiment of the present invention, a system for utilizing different user identifiers for performing activities of applications based on activity context comprises one or more memories and at least one processor coupled to the one or more memories. The system determines context information for an activity of an application performed by a user. A non-fungible token of the user is identified with one or more attributes corresponding to the context information. The application is directed to use the identified non-fungible token as a user identifier for performing the activity. Embodiments of the present invention further include a method and computer program product (e.g., including one or more computer readable media with instructions executable by one or more processors) for utilizing different user identifiers for performing activities of applications based on activity context in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3 is a flowchart of a method of identifying a set of non-fungible tokens (NFTs) for use as profile pictures (PFPs) for a user according to an embodiment of the present invention.

FIG. 4 is a flowchart of a method of dynamically utilizing a non-fungible token (NFT) as a profile picture (PFP) based on a context of an activity according to an embodiment of the present invention.

FIG. 5 is flowchart of a method of selecting a non-fungible token (NFT) for use as a profile picture (PFP) for a user based on context of an activity according to an embodiment of the present invention.

FIG. 6 is an example of a graphical user interface (GUI) screen that enables selection of one or more non-fungible tokens (NFTs) for use as a profile picture (PFP) for a user according to an embodiment of the present invention.

FIG. 7 is an example of a graphical user interface (GUI) screen that presents non-fungible tokens (NFTs) for selection as a profile picture (PFP) for a user according to an embodiment of the present invention.

FIG. 8A is an example of a graphical user interface (GUI) screen illustrating a user on a channel associated with a first non-fungible token (NFT) collection according to an embodiment of the present invention.

FIG. 8B is an example of a graphical user interface (GUI) screen illustrating a user responding to an electronic message associated with a non-fungible token (NFT) collection according to an embodiment of the present invention.

FIG. 8C is an example of a graphical user interface (GUI) screen illustrating a user responding to an electronic message associated with another non-fungible token (NFT) collection according to an embodiment of the present invention.

### DETAILED DESCRIPTION

A profile picture (PFP) for a user is typically associated with social media and online identity accounts. A non-fungible token (NFT) is a crypto type asset with each token being unique (and representing items, such as digital art, music, or video game items), whereas fungible tokens (e.g., coins of the same cryptocurrency) have the same value of worth and are exchangeable. Non-fungible tokens (NFTs) may be used as profile pictures (PFPs) (or profile picture non-fungible tokens (PFP NFTs)), where a profile picture non-fungible token (PFP NFT) is associated with a crypto wallet having an address that proves user ownership. However, often times a user collects multiple non-fungible tokens (NFTs) which leads to more than one non-fungible token (NFT) in their collection that may be used as a profile picture (PFP).

Accordingly, an embodiment of the present invention selects from a set of profile picture non-fungible tokens (PFP NFTs) which PFP NFT to display as the primary profile picture (PFP) for a user for various contextual situations and experiences. The present invention embodiment dynamically determines a most contextually relevant profile picture non-fungible token (PFP NFT) for a user digital identity based on a context of an activity to be performed (e.g., an information or communication channel associated with the activity, a message associated with the activity, a non-fungible token (NFT) community associated with the activity, a non-fungible token (NFT) community in common between interacting users, etc.). The profile picture non-fungible token (PFP NFT) may be displayed with a visual indicator (e.g., box, asterisk, checkmark, etc.) to indicate the profile picture (PFP) is a non-fungible token (NFT) owned by the user. This authenticates the user identity for the activity to provide enhanced security (e.g., a message posted on a channel can be easily and quickly verified as being from the actual user, etc.). Further, the profile picture non-fungible token (PFP NFT) may be used to grant or deny access to a channel, community, or application (e.g., the profile picture non-fungible token (PFP NFT) can confirm ownership by a user of a non-fungible token (NFT) of a community or collection for access to the channel, community, or application, etc.).

For example, a user may be on a social media or other channel associated with a non-fungible token (NFT) community, and the present invention embodiment provides a non-fungible token (NFT) of the user corresponding to that community for use as the profile picture (PFP) for the user.

Further, the user may be on a social media site and interact with messages associated with a non-fungible token (NFT) community. By way of example, the message may be on a channel associated with a non-fungible token (NFT) community, or be from a sending user having a handle (or profile picture (PFP)) associated with a non-fungible token (NFT) community. In these cases, the present invention embodiment provides a non-fungible token (NFT) of the user corresponding to the non-fungible token (NFT) community for use as the profile picture (PFP) for the user.

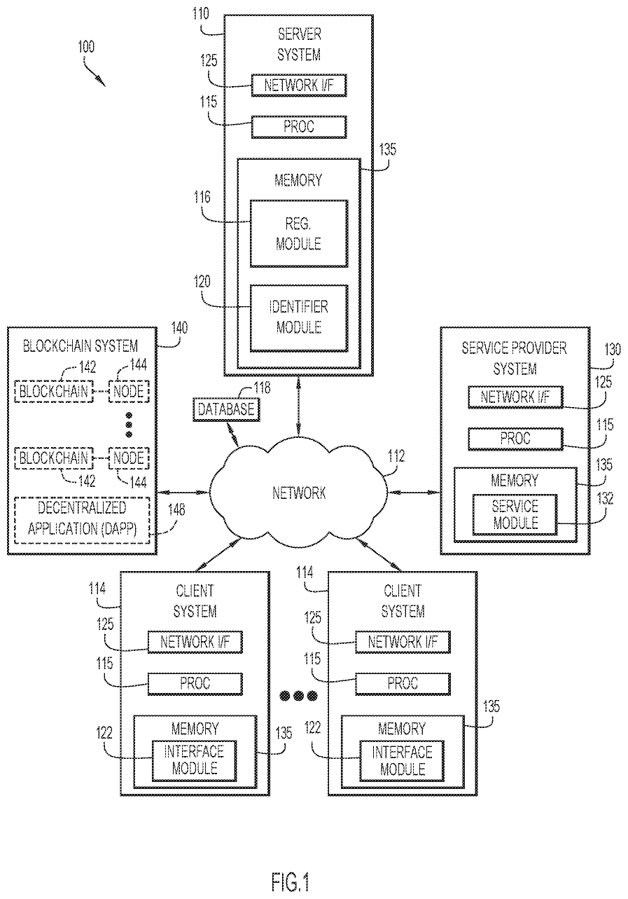

An example environment 100 for use with present invention embodiments is illustrated in FIG. 1. Specifically, environment 100 includes one or more server systems 110, one or more client or end-user systems 114, one or more service provider systems 130, and one or more blockchain systems 140 each implementing and maintaining at least one corresponding blockchain 142. Server systems 110, client systems 114, service provider systems 130, and/or blockchain systems 140 may be remote from each other and communicate over a network 112. The network may be implemented by any number of any suitable communications media (e.g., wide area network (WAN), local area network (LAN), Internet, Intranet, etc.). Alternatively, server systems 110, client systems 114, service provider systems 130, and/or blockchain systems 140 may be local to each other, and communicate via any appropriate local communication medium (e.g., local area network (LAN), hardwire, wireless link, Intranet, etc.).

Server systems 110 include a registration module 116 and an identifier module 120. Registration module 116 interfaces with a user via client system 114 to perform blockchain or other domain name registration and/or manage crypto or other assets for users. The registration module may further maintain profile information for the user including non-fungible tokens (NFTs) to be used as profile pictures (PFPs). Identifier module 120 determines a corresponding non-fungible token (NFT) of a user to use a profile picture (PFP) for an activity based on the context of the activity as described below (e.g., an information or communication channel associated with the activity, a message associated with the activity, a non-fungible token (NFT) community associated with the activity, a non-fungible token (NFT) community in common between interacting users, etc.).

Service provider systems 130 may include any third party or other server systems implementing or providing blockchains (e.g., blockchains 142, etc.), various social media or other network sites, and/or other services (e.g., blockchain management, domain registry management, user accounts of network sites, non-fungible token (NFT) exchange or marketplace, non-fungible token (NFT) minting platform, etc.). The service provider systems include one or more service modules 132 to provide the various services (e.g., blockchain management, domain registry management, user accounts of network sites, non-fungible token (NFT) exchange or marketplace, non-fungible token (NFT) minting platform, etc.).

Client systems 114 may include an interface module 122 to provide a graphical user (e.g., GUI, etc.) or other interface (e.g., command line prompts, menu screens, etc.) that enables users to access server systems 110 and/or service provider systems 130 for registering blockchain or other domain names, managing crypto or other assets, and/or utilizing social media or other services. The interface module may include any conventional or other browser to access server systems 110 and/or service provider systems 130.

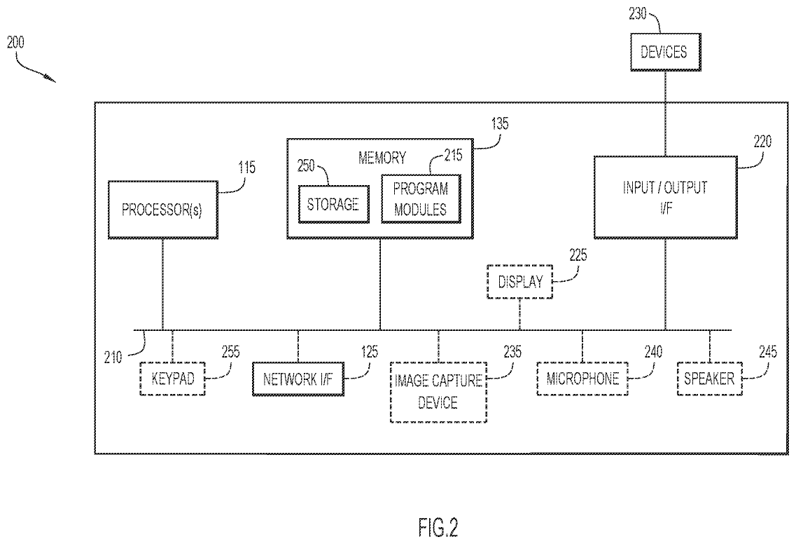

Blockchain systems 140 may each include one or more nodes 144 to implement and maintain at least one corresponding blockchain 142. The nodes may be implemented by any suitable computing devices (e.g., as described below for FIG. 2). The blockchain is generally in the form of a ledger that includes a series of records or blocks chained or linked together. The blockchain is typically managed by a peer-to-peer network (of nodes 144) and used as a distributed ledger. Nodes 144 of the peer-to-peer network communicate and verify new blocks according to a protocol. The peer-to-peer network provides a decentralized approach, where each node has a copy of a blockchain 142. Transactions are transmitted to the peer-to-peer network, where mining nodes (nodes 144) process the transactions. The mining nodes validate a transaction, insert the transaction into a current block, and transmit the block to the other nodes. Blockchain 142 may be implemented by any conventional or other blockchain, and may be a public (e.g., no access restrictions, etc.), private (e.g., restricted access, etc.), or hybrid (e.g., with centralized and decentralized features) blockchain.

Blockchain systems 140 may include one or more decentralized or distributed applications (dApps) 148 to perform various operations (e.g., financial or other transactions related to a blockchain, social media operations, provide access to communication and/or information channels, etc.).

Interface module 122 of client systems 114 may further provide a graphical user (e.g., GUI, etc.) or other interface (e.g., command line prompts, menu screens, etc.) that enables users to access decentralized applications (dApps) 148 on blockchain systems 140 for performing various operations (e.g., financial or other transactions related to a blockchain, social media operations, provide access to communication and/or information channels, etc.). The interface module may include any conventional or other browser to access the decentralized applications (dApps) of blockchain systems 140. The interface module may natively, or include extensions to, access the decentralized applications (dApps). The interface module may provide a user interface to serve as a front end for a decentralized application (dApp) 148, where back end processing for the decentralized application (dApp) is performed on a blockchain system 140. Client systems 114 may further provide reports or notifications pertaining to requests (e.g., determined non-fungible token (NFT) to use as a profile picture (PFP), information for selection of a non-fungible token (NFT) for use as a profile picture (PFP), etc.).

A database system 118 may store various information for the dynamic selection and utilization of non-fungible tokens (NFTs) as profile pictures (PFPs) (e.g., mappings of applications or channels to non-fungible token (NFT) communities or collections, metadata and/or properties associated with non-fungible tokens (NFTs), etc.). The database system may be implemented by any conventional or other database or storage unit, may be local to or remote from server systems 110, client systems 114, service provider systems 130, and/or blockchain systems 140 and may communicate via any appropriate communication medium (e.g., local area network (LAN), wide area network (WAN), Internet, hardwire, wireless link, Intranet, etc.).

Server systems 110, client systems 114, and service provider systems 130 may be implemented by any conventional or other computer systems preferably equipped with a display or monitor, a base, optional input devices (e.g., a keyboard, mouse or other input device), and any software for use by present invention embodiments (e.g., server/communications software, blockchain software, registration module 116, identifier module 120, interface module 122, service module 132, etc.). The base may include at least one hardware processor 115 (e.g., microprocessor, controller, central processing unit (CPU), etc.), one or more memories 135, and/or internal or external network interfaces or communications devices 125 (e.g., modem, network cards, etc.)).

Registration module 116, identifier module 120, interface module 122, service modules 132, and decentralized applications (dApps) 148 may include one or more modules or units to perform the various functions of present invention embodiments described below. The various modules (e.g., registration module 116, identifier module 120, interface module 122, service modules 132, etc.) may be implemented by any combination of any quantity of software and/or hardware modules or units, and may reside within memory 135 of the server, client and/or service provider systems for execution by a corresponding processor 115. The various modules of the blockchain (e.g., decentralized applications (dApps) 148, etc.) may be implemented by any combination of any quantity of software and/or hardware modules or units, and may reside on a blockchain 142 for execution by one or more nodes 144.

An example of a computing device 200 for environment 100 (e.g., implementing server systems 110, client systems 114, service provider systems 130, blockchain systems 140, nodes 144, etc.) is illustrated in FIG. 2. The example computing device may perform the functions of present invention embodiments described herein. Computing device 200 may be implemented by any personal or other type of computer or processing system (e.g., desktop, laptop, hand-held device, smartphone or other mobile device, etc.), and may be used for any computing environments (e.g., cloud computing, client-server, network computing, mainframe, stand-alone systems, etc.).

Computing device 200 may include one or more processors 115 (e.g., microprocessor, controller, central processing unit (CPU), etc.), network interface 125, memory 135, a bus 210, and an Input/Output interface 220. Bus 210 couples these components for communication, and may be of any type of bus structure, including a memory bus or memory controller, a peripheral bus, and a processor or local bus using any of a variety of conventional or other bus architectures. Memory 135 is coupled to bus 210 and typically includes computer readable media including volatile media (e.g., random access memory (RAM), cache memory, etc.), non-volatile media, removable media, and/or non-removable media. For example, memory 135 may include storage 250 containing nonremovable, non-volatile magnetic or other media (e.g., a hard drive, etc.). The computing device may further include a magnetic disk drive and/or an optical disk drive (not shown) (e.g., CD-ROM, DVD-ROM or other optical media, etc.) connected to bus 210 via one or more data interfaces.

Moreover, memory 135 includes a set of program modules 215 (e.g., corresponding to registration module 116, identifier module 120, interface module 122, service modules 132, blockchain software (e.g., decentralized applications (dApp) 148, blockchain management software, etc.), network site or service software, etc.) that are configured to perform functions of present invention embodiments described herein. The memory may further include an operating system, at least one application and/or other modules, and corresponding data. These may provide an implementation of a networking environment.

Input/Output interface 220 is coupled to bus 210 and communicates with one or more peripheral or external devices 230 (e.g., a keyboard, mouse or other pointing device, a display, biometric sensing devices, etc.), at least one device that enables a user to interact with computing device 200, and/or any device (e.g., network card, modem, etc.) that enables computing device 200 to communicate with one or more other computing devices. Computing device 200 may communicate with one or more networks (e.g., a local area network (LAN), a wide area network (WAN), a public network (e.g., the Internet), etc.) via network interface 125 coupled to bus 210.

With respect to certain entities (e.g., client system 114, etc.), computing device 200 may further include, or be coupled to, a touch screen or other display 225, a camera or image capture device 235, a microphone or other sound sensing device 240, a speaker 245 to convey sound, and/or a keypad or keyboard 255 to enter information (e.g., alphanumeric information, etc.). These items may be coupled to bus 210 or Input/Output interface 220 to transfer data with other elements of computing device 200.

Initially, a blockchain (e.g., blockchain 142, etc.) is generally in the form of a ledger that includes a series of records or blocks chained or linked together. Each block includes a hash of the prior block in the blockchain, a timestamp, and transaction information. The hash of the prior block enables the blockchain to be resistant to modification since changes to data in any prior block alter the hash value which propagates to subsequent blocks.

A blockchain is typically managed by a peer-to-peer network and used as a distributed ledger. Nodes of the peer-to-peer network communicate and verify new blocks according to a protocol. The peer-to-peer network provides a decentralized approach, where each node has a copy of the blockchain. Transactions are transmitted to the network, where mining nodes process the transactions. The mining nodes validate a transaction, insert the transaction into a current block, and transmit the block to the other nodes. Various consensus approaches may be used for combining validation results of different mining nodes to determine validity of a transaction (or block).

Users of transactions for the blockchain are authenticated based on cryptographic keys. These keys identify a user and provide access to a user account or wallet. The user wallet is basically an application or software that enables users to store and access digital assets (e.g., for receiving or sending cryptocurrency or other fungible tokens, non-fungible tokens (NFTs), etc.). For example, a non-fungible token (NFT) is a crypto type asset with each token being unique (and representing items, such as digital art, music, or video game items), whereas fungible tokens (e.g., coins of the same cryptocurrency) have the same value of worth and are exchangeable. Each user is associated with their own private key (e.g., accessible only to the associated user, etc.) and a public key (e.g., typically an address on the blockchain). The private and public keys enable authentication of the user based on digital signatures in order to commence a transaction. The user account or wallet typically stores the private key.

For example, in order for the user to send cryptocurrency, a message for a transaction is encrypted with the private key of the user wallet. The private key enables only the user to control the user wallet. A digital signature is created by encrypting the message with the private key, where the digital signature is used to verify the user and transaction. The message may be decrypted with the corresponding public key of the user wallet. Since the private key is unique to the user, successful decryption of the message with the corresponding public key verifies the message was sent by the user. Once verified, the transaction may be posted to the blockchain, thereby adjusting the user wallet based on the transaction.

In addition, a blockchain may store software (e.g., typically referred to as smart contracts) that executes in response to occurrence of pre-defined conditions. A smart contract is generally software or a program that runs on the blockchain. The code and data for the smart contract reside at a specific address on the blockchain. Non-fungible tokens (NFTs) are controlled by smart contracts that handle transference and verification of ownership of the non-fungible tokens (NFTs). A blockchain may be public (e.g., no access restrictions, etc.), private (e.g., restricted access, etc.), or hybrid (e.g., with centralized and decentralized features).

A blockchain domain name is stored on a blockchain. The blockchain domain name may be a non-fungible token (NFT) domain name that is associated with a non-fungible token (NFT) stored in a user wallet. The blockchain domain name may be associated with various information (e.g., wallet addresses, user information (e.g., name, address, email, etc.), data or other access restrictions, etc.). The blockchain domain name is associated with software or smart contracts on the blockchain that may perform various functions (e.g., provide a registry for corresponding wallet addresses, indicate locations of content for the domain (e.g., or a website, etc.) hosted on the blockchain or other system, etc.). In order to access a blockchain domain, the blockchain is accessed to find the record corresponding to the blockchain domain name (which may initiate the corresponding smart contracts for the corresponding functionality). The private key of the user wallet enables the user to have sole control of the blockchain domain name (e.g., authenticating operations or transactions for the blockchain domain name similar to the cryptocurrency example described above, etc.). For example, the user may have sole control to perform operations that alter content and/or functionality for the blockchain domain name.

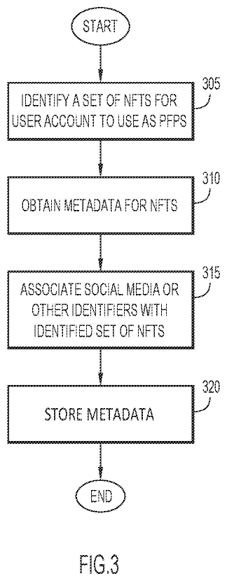

A method of identifying a set of non-fungible tokens (NFTs) for use as profile pictures (PFPs) for a user (e.g., via registration module 116 and server system 110, service module 132 and service provider system 130, and/or client system 114) according to an embodiment of the present invention is illustrated in FIG. 3. Initially, a user desires to use one or more non-fungible tokens (NFTs) as profile pictures (PFPs) for one or more activities of various applications (e.g., decentralized application 148, service module 132, etc.). The non-fungible tokens (NFTs) of the user are preferably associated with digital artwork or images, where an associated digital artwork or image of a non-fungible token (NFT) may be used as a profile picture (PFP) and presented on social media or other platforms to identify the user (e.g., placed in a message sent by the user, used to identify the user in a thread, used to identify the user in a channel, etc.).

A set of non-fungible tokens (NFTs) are identified for an account of a user for use as profile pictures (PFPs) at operation 305. An indication of the non-fungible tokens (NFTs) of the set to be used as profile pictures (PFPs) may be stored on a blockchain and associated with a user wallet. For example, the indication may include a flag or other indicator or identifier to indicate the non-fungible tokens (NFTs) of the user to be used as profile pictures (PFPs) (e.g., a flag for individual non-fungible tokens (NFTs), a list of non-fungible tokens (NFTs) to be used as profile pictures (PFPs), etc.).

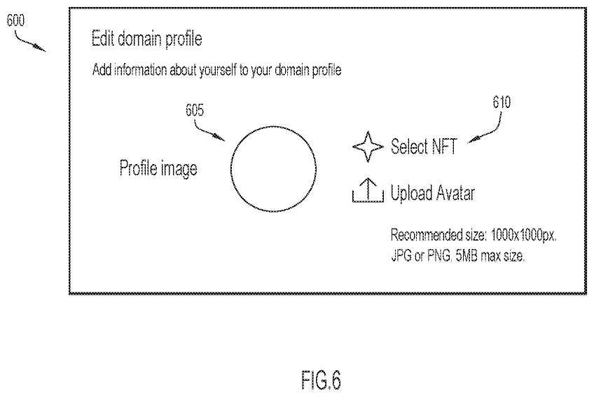

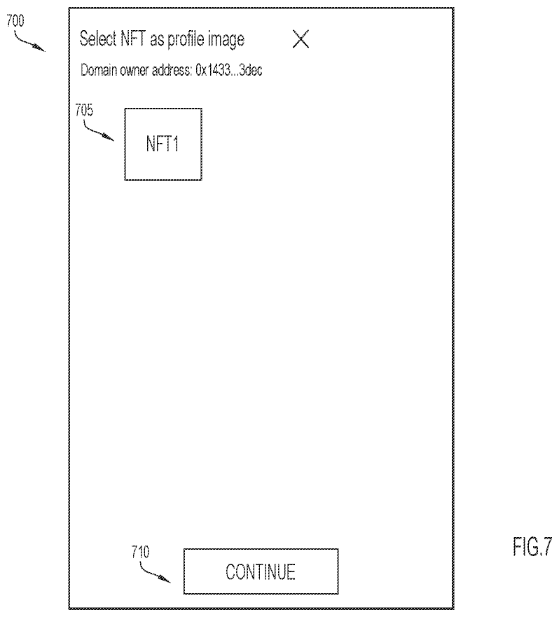

For example, a user may log in to a user account of an application (e.g., registration module 116 of server system 110) that handles crypto or other assets (e.g., fungible and/or non-fungible tokens (NFTs), etc.) of the user. The login may use any conventional or other process (e.g., username/password, wallet verification, etc.). The application may maintain a user profile for a user that contains various user information (e.g., name, mailing address, email address, blockchain (or wallet) addresses of the user for various blockchains, etc.). The application may enable the user to register blockchain or other domain names, update the user profile, and/or manage crypto or other assets. The application may present and enable selection of non-fungible tokens (NFTs) of the user for use as profile pictures (PFP) (e.g., in a manner similar to FIGS. 6 and 7 described below).

Further, the user may log in to a user account of an application (e.g., decentralized application 148, service module 132, etc.) that provides a non-fungible token (NFT) marketplace or minting platform. The login may use any conventional or other process (e.g., username/password, wallet verification, etc.). The application may maintain various user information (e.g., name, mailing address, email address, blockchain (or wallet) addresses of the user for various blockchains, etc.). The application may enable the user to acquire or mint non-fungible tokens (NFTs) or other assets, and may further present and enable selection of non-fungible tokens (NFTs) of the user for use as profile pictures (PFP) (e.g., in a manner similar to FIGS. 6 and 7 described below).

The identification of the set of non-fungible tokens (NFTs) for use as profile pictures (PFP) may be accomplished by the application (e.g., registration module 116, service module 132, decentralized application 148, etc.) initially performing a lookup of available non-fungible tokens (NFTs) of the user based on a user wallet address. The wallet address may be provided by the user, and/or obtained from user information maintained for the user account. In this case, a corresponding blockchain 142 of a blockchain system 140 may be accessed to examine records pertaining to the user wallet address and determine non-fungible tokens (NFTs) of the user. The determined non-fungible tokens (NFTs) may be presented to the user for selection for use as profile pictures (PFPs) (e.g., in a manner similar to FIGS. 6 and 7 described below). An indication of the non-fungible tokens (NFTs) of the set to be used as profile pictures (PFPs) may be stored on the blockchain and associated with a user wallet. For example, the indication may include a flag or other indicator or identifier to indicate the non-fungible tokens (NFTs) of the user to be used as profile pictures (PFPs) (e.g., a flag for individual non-fungible tokens (NFTs), a list of non-fungible tokens (NFTs) to be used as profile pictures (PFPs), etc.).

Alternatively, the identification of the set of non-fungible tokens (NFTs) for use as profile pictures (PFPs) may be accomplished by the user manually uploading one or more selected ones of their non-fungible tokens (NFTs) to a central or decentralized storage platform (e.g., a blockchain, decentralized storage, off-chain storage (e.g., database system 118, etc.), etc.). The user may upload the selected non-fungible tokens (NFTs) to the storage platform from an application (e.g., registration module 116, service module 132, decentralized application 148, etc.). For example, the user may provide an identifier and/or other attributes for a selected non-fungible token (NFT) (e.g., name, collection, wallet address, etc.) to the application to enable the application to retrieve and upload the non-fungible token (NFT) from the user wallet (or a blockchain) to the storage platform. An indication of the non-fungible tokens (NFTs) to be used as profile pictures (PFPs) may be stored on the storage platform and associated with the user (e.g., user wallet, user account, etc.). For example, the indication may include a flag or other indicator or identifier to indicate the non-fungible tokens (NFTs) of the user to be used as profile pictures (PFPs) (e.g., a flag for individual non-fungible tokens (NFTs), a list of non-fungible tokens (NFTs) to be used as profile pictures (PFPs), etc.).

The application (e.g., registration module 116, service module 132, decentralized application 148, etc.) obtains and associates metadata with each identified non-fungible token (NFT) at operation 310. The metadata is typically provided for a non-fungible token (NFT) at a time of minting the nonfungible token (NFT). However, the metadata may be provided or updated at any time. The metadata may be provided by the user (e.g., via a user interface) and/or generated automatically (e.g., based on attributes of the non-fungible token (NFT), attributes of the user, attributes of the application, etc.). The metadata may include various information, such as non-fungible token (NFT) collection attributes (e.g., name of the collection, description of the collection, etc.), a minter (or user) of the non-fungible token (NFT), keywords and/or properties of the non-fungible token (NFT) (e.g., features of an object portrayed in digital artwork or an image associated with the non-fungible token (NFT) (e.g., facial or bodily features, accessories, etc.)), etc.

In addition, the application (e.g., registration module 116, service module 132, decentralized application 148, etc.) may further associate each identified non-fungible token (NFT) with handles of the user, channels, and/or social media or other platforms (e.g., TWITTER, DISCORD, ETHERSCAN, INSTAGRAM, a website, etc.) at operation 315. This information may be provided by the user (e.g., via a user interface) and included in the metadata, and enables identification of a non-fungible token (NFT) to be used as a profile picture (PFP) based on a context of an activity (e.g., user handle, channel, etc.) performed on a social media or other platform as described below. For example, the metadata may include a listing of channels and/or social media or other platforms (e.g., TWITTER, DISCORD, ETHERSCAN, INSTAGRAM, a website, etc.) and corresponding handles for those channels and/or platforms. When no handles are provided for a listed channel and/or platform, the corresponding non-fungible token (NFT) may be used for all activities of that listed channel and/or platform. A non-fungible token (NFT) selected for use as a profile picture (PFP) may be associated with one or more handles of the same or different channels and/or social media or other platforms.

By way of example, metadata for a non-fungible token (NFT) to be used as a profile picture (PFP) may indicate one or more handles for a first social media platform, and one or more handles for a second social media platform. In this case, the non-fungible token (NFT) will be dynamically selected and used as a profile picture (PFP) when the user uses the indicated handles on the first and/or second social media platforms.

The application (e.g., registration module 116, service module 132, decentralized application 148, etc.) preferably stores the metadata on a blockchain 142 of a blockchain system 140 at operation 320 to associate the metadata with a corresponding non-fungible token (NFT) (and user wallet address). However, the metadata may be stored on any central or decentralized storage platform (e.g., a blockchain, decentralized storage, off-chain storage (e.g., database system 118, etc.), etc.) based on non-fungible token (NFT) and/or user attributes (e.g., wallet address, etc.).

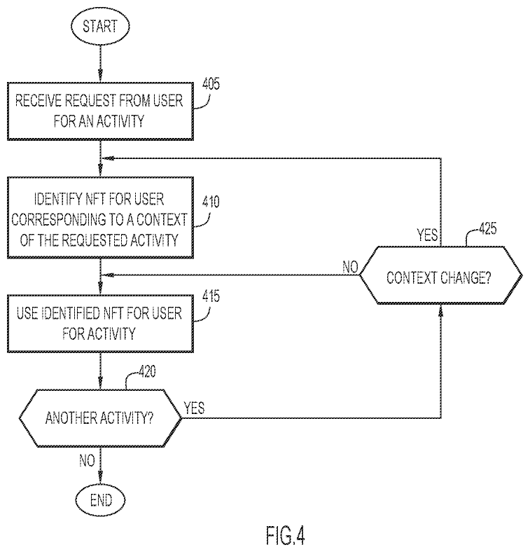

A method of dynamically utilizing a non-fungible token (NFT) as a profile picture (PFP) based on a context of an activity (e.g., via service module 132, decentralized application 148, service provider system 130, blockchain system 140, and a client system 114) according to an embodiment of the present invention is illustrated in FIG. 4. Initially, a user accesses or interacts with an application (e.g., service module 132 of a service provider system 130, decentralized application 148 of a blockchain system 140, etc.) via a client system 114. The application (e.g., service module 132, decentralized application 148, etc.) may provide communication and/or information channels or platforms for engagement by a user via client system 114. A channel may be associated with a non-fungible token (NFT) community or collection. For example, an information or communication channel may be associated with a collection of non-fungible tokens (NFTs), where users of the channel own one or more non-fungible tokens (NFTs) of the collection. By way of further example, messages may use non-fungible tokens (NFTs) of various collections as a user identifier (e.g., profile picture (PFP), etc.) to indicate a user sending a message.

The application (e.g., service module 132, decentralized application 148, etc.) receives and processes a request from a user (e.g., via client system 114) to perform an activity or action at operation 405. The activity may include participation or engagement on a channel provided by the application and/or sending messages to other users. For example, a user may participate in conversations or threads of a channel and/or send messages on a channel, where the channel may correspond to social media or other platforms. Further, the user may respond to messages having a non-fungible token (NFT) as a profile picture (PFP) of a sending user.

The application (e.g., service module 132, decentralized application 148, etc.) determines a context for the requested activity, and identifies a non-fungible token (NFT) of the user to use as a profile picture (PFP) for the requested activity based on a context of the requested activity at operation 410. The context of an activity may pertain to an information or communication channel associated with the activity, a message associated with the activity, a non-fungible token (NFT) community or collection associated with the activity, a non-fungible token (NFT) community or collection in common between interacting users, etc. The application may determine a context of the requested activity based on names, identifiers, or other attributes of handles, channels, messages and/or social media or other platforms associated with the requested activity (e.g., non-fungible tokens (NFT) used as a profile pictures (PFP) of users of messages, names or other identifiers of the channels or platforms, associated non-fungible token (NFT) collections or communities of the channels or platforms, etc.).

For example, the application may enable activities for a specific non-fungible token (NFT) community or collection. In this case, the application (e.g., name, description, platform, etc.) may be mapped to a corresponding context (e.g., the specific non-fungible token (NFT) community or collection, etc.), where the mapping or context may be indicated by an identifier. The mapping of the identifier to a context may be stored in any suitable storage platform (e.g., database system 118, a blockchain, decentralized storage system, etc.).

The application may determine the non-fungible token (NFT) of the user to use as the profile picture (PFP), or request the non-fungible token (NFT) from identifier module 120 of server system 110. The application may provide context information and/or the identifier to the identifier module to indicate a context for the requested activity for determining the non-fungible token (NFT) of the user to use as the profile picture (PFP). The context information may include attributes of the user (e.g., wallet address, user information (e.g., name, address, email, etc.), user handle, etc.), attributes of another user interacting with the user (e.g., wallet address, user information (e.g., name, address, email, etc.), user handle, etc.), and/or attributes of a non-fungible token (NFT) associated with the activity (e.g., a name and/or description of a non-fungible token (NFT) community or collection associated with the activity, a name and/or description of a non-fungible token (NFT) community or collection in common between interacting users, properties of a non-fungible token (NFT) associated with the activity, a channel name, a channel handle, etc.).

For example, the user may be participating on a channel associated with a particular non-fungible token (NFT) community or collection. In this case, the context information may include the name or description of the non-fungible token (NFT) community or collection, user handle, and/or user attributes (e.g., wallet address, user information (e.g., name, address, email, etc.), etc.) which may be used in order to ascertain a non-fungible token (NFT) of the user corresponding to that community or collection.

By way of further example, a user may respond to a message from another user having a non-fungible token (NFT) as a profile picture (PFP) for the message. The application may retrieve the non-fungible token (NFT) collection for the NFT of the message based on metadata of the message (e.g., name and/or description of the non-fungible token (NFT) in message metadata, retrieve the name and/or description of the collection from metadata stored on a blockchain for the non-fungible token (NFT) of the message based on a sending user handle, channel, or social media platform, etc.). In this case, the context information may include the name or description of the non-fungible token (NFT) community or collection of the message, user handle, and/or user attributes (e.g., wallet address, user information (e.g., name, address, email, etc.), etc.) which may be used in order to ascertain a non-fungible token (NFT) of the user corresponding to that community or collection.

In addition, the context information may indicate properties of the digital artwork or image associated with a non-fungible token (NFT) for an activity. For example, a user may respond to a message from another user having a non-fungible token (NFT) as a profile picture (PFP) for the message. The application may retrieve information for the non-fungible token (NFT) of the message based on metadata of the message (e.g., name and/or description of the non-fungible token (NFT) in message metadata, retrieve the name and/or description of the collection from metadata stored on a blockchain for the non-fungible token (NFT) of the message based on a sending user handle, channel, and/or social media platform, etc.). However, a non-fungible token (NFT) collection or community may not be able to be determined for the non-fungible token (NFT) of the message. In these types of cases, the context information may include properties of the non-fungible token (NFT) of the activity from metadata (e.g., produced at the time of minting, etc.). The properties may include features of an object portrayed in digital artwork or an image associated with the non-fungible token (NFT) (e.g., facial or bodily features, accessories, etc.).

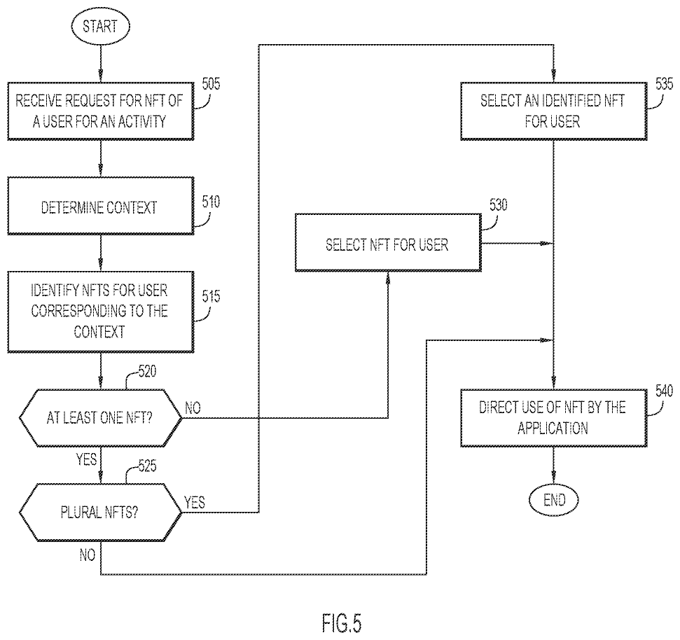

The non-fungible token (NFT) for use as the profile picture (PFP) may be determined by identifier module 120 or the application based on the context of the activity in substantially the same manner described below (e.g., for FIG. 5). Once the non-fungible token (NFT) to use as the profile picture (PFP) is identified, attributes of the identified non-fungible token (NFT) (e.g., name and/or description of the non-fungible token (NFT), wallet address, user information (e.g., name, address, email, etc.), etc.) are provided (e.g., by identifier module 120 or the application) in order to enable or direct retrieval of the non-fungible token (NFT) (or associated digital artwork or image) from the wallet (or blockchain) and use as the profile picture (PFP).

The application (e.g., service module 132, decentralized application 148, etc.) uses the identified non-fungible token (NFT) as the profile picture (PFP) of the user for the activity at operation 415. This may be accomplished by the application using the attributes of the identified non-fungible token (NFT) (e.g., determined by identifier module 120 or the application) to retrieve the non-fungible token (NFT) (or associated digital artwork or image) from the wallet (or blockchain). Alternatively, identifier module 120 may provide a copy of the digital artwork or image of the identified non-fungible token (NFT).

The digital artwork or image of the identified non-fungible token (NFT) may be used as a profile picture (PFP) to identify the user for the activity. For example, a comment generated by the user for a conversation or thread of a channel associated with a non-fungible token (NFT) community or collection may include a profile picture (PFP) having a non-fungible token (NFT) of the user from that collection (thereby corresponding to the context of the activity). Similarly, a response by the user to a message includes a profile picture (PFP) having a non-fungible token (NFT) of the user from the same collection as a non-fungible token (NFT) used as a profile picture (PFP) in the message for a sending user (thereby corresponding to the context of the activity).

The non-fungible token (NFT) used as a profile picture (PFP) may be displayed with a visual indicator (e.g., box, asterisk, checkmark, etc.) to indicate the profile picture (PFP) is a non-fungible token (NFT) owned by the user. This authenticates the user identity for the activity to provide enhanced security (e.g., a message or comment posted or sent on a channel or platform can be easily and quickly verified as being from the actual user, etc.).

Further, the non-fungible token (NFT) used as a profile picture (PFP) may be used to grant or deny access to a channel, community, or application. For example, a channel or application may be associated with a non-fungible token (NFT) community or collection. The non-fungible token (NFT) used as a profile picture (PFP) can confirm ownership by the user of a non-fungible token (NFT) of the community or collection. The application may use a presence of a corresponding non-fungible token (NFT) to determine to grant or deny access to the user to the channel, community, or application (e.g., allow or prevent the user to post or send messages or comments, etc.). By way of example, when a non-fungible token (NFT) of the user is identified that corresponds to the context (e.g., channel, community, or application), the user may be granted access to the channel, community, or application to perform activities (with the identified non-fungible token (NFT) used as the profile picture (PFP)). However, when no non-fungible token (NFT) of the user is identified that corresponds to the context (e.g., channel, community, or application), the user may be denied access to the channel, community, or application.

When another activity is requested by the user as determined at operation 420, the context of the other activity is determined (e.g., an information or communication channel associated with the activity, a message associated with the activity, a non-fungible token (NFT) community or collection associated with the activity, a non-fungible token (NFT) community in common between interacting users, etc.). The context may be determined for the other activity in substantially the same manner described above.

When the context for the other activity has changed as determined at operation 425, the non-fungible token (NFT) used for the profile picture (PFP) may also need to change to accommodate the changed context. The determination of a changed context may be based on a comparison of names, identifiers, or other attributes associated with the initial and subsequently requested activities (e.g., non-fungible tokens (NFT) used as a profile pictures (PFP) of users of the initial and subsequently requested activities, names or other identifiers associated with the initial and subsequently requested activities, associated non-fungible token (NFT) communities or collections of the initial and subsequently requested activities, etc.). For example, the application may detect that a user switched to a different channel or message (e.g., associated with a different non-fungible token (NFT) community or collection, etc.). The detection may be based on a comparison of names, identifiers, or other attributes of the initial and switched channels or messages (e.g., non-fungible tokens (NFT) used as a profile pictures (PFP) of users of the initial and switched messages, names or other identifiers of the initial and switched channels, associated non-fungible token (NFT) communities or collections of the initial and switched channels, etc.).

When one or more of the names, identifiers, or other attributes associated with the subsequently requested activity is different than the corresponding ones of the initial activity, the context may be considered to have changed. Any quantity of changed attributes may be utilized to indicate a changed context. Accordingly, when the context is determined to have changed, the process repeats from operation 410 to identify and use a non-fungible token (NFT) of the user as a profile picture (PFP) for the other activity based on the context of the other activity in substantially the same manner described above.

When the context for the other activity has not changed as determined at operation 425, the non-fungible token (NFT) used for the profile picture (PFP) of the user may continue to be used. For example, when a sufficient quantity of the names, identifiers, or other attributes associated with the subsequently requested activity are the same as the corresponding ones of the initial activity, the context may be considered to have remained the same. Any quantity of unchanged attributes may be utilized to indicate a context has remained the same. By way of example, the application may detect that the user remained on the same channel or message or switched to another channel or message associated with the same non-fungible token (NFT) community or collection. The detection may be based on a comparison of names, identifiers, or other attributes associated with the initial and switched channels or messages in substantially the same manner described above (e.g., non-fungible tokens (NFT) used as a profile pictures (PFP) of users of the initial and switched messages, names or other identifiers of the initial and switched channels, associated non-fungible token (NFT) communities or collections of the initial and switched channels, etc.).

Accordingly, when the context has been determined to remain the same, the process repeats from operation 415 to use the same non-fungible token (NFT) of the user as the profile picture (PFP) for the other activity in substantially the same manner described above. The above process continues until no further activities are requested as determined at operation 420.

A method of identifying a non-fungible token (NFT) for use as a profile picture (PFP) for a user based on a context of an activity (e.g., via identifier module 120 and server system 110) according to an embodiment of the present invention is illustrated in FIG. 5. Initially, a user accesses (e.g., logs in, navigates to, etc.) and interacts with an application (e.g., service module 132 of a service provider system 130, decentralized application 148 of a blockchain system 140, etc.) via a client system 114. The login may use any conventional or other process (e.g., username/password, wallet verification, etc.). The application (e.g., service module 132, decentralized application 148, etc.) may provide communication and/or information channels or platforms for engagement by a user via client system 114 to perform one or more activities. A channel may be associated with a non-fungible token (NFT) community or collection. For example, an information or communication channel may be associated with a collection of non-fungible tokens (NFTs), where users of the channel own one or more non-fungible tokens (NFTs) of the collection. By way of further example, messages may use non-fungible tokens (NFTs) of various collections as a user identifier (e.g., profile picture (PFP), etc.) to indicate a user sending a message.

By way of example, the application (e.g., service module 132, decentralized application 148, etc.) may provide a request to identifier module 120 of server system 110 to ascertain a non-fungible token (NFT) of the user to use as a profile picture (PFP) based on a context of an activity performed by the user. The identifier module receives a request from the application for a non-fungible token (NFT) of the user to use as a profile picture (PFP) for an activity at operation 505. The identifier module determines a context of the activity based on information in the request at operation 510. The context of the activity may pertain to an information or communication channel associated with the activity, a message associated with the activity, a non-fungible token (NFT) community or collection associated with the activity, a non-fungible token (NFT) community or collection in common between interacting users, etc. The information in the request may include context information indicating user attributes and the context for the activity. The context information may include attributes of the user (e.g., wallet address, user information (e.g., name, address, email, etc.), user handle, etc.), attributes of another user interacting with the user (e.g., wallet address, user information (e.g., name, address, email, etc.), user handle, etc.), and/or a non-fungible token (NFT) associated with the activity (e.g., a name and/or description of a non-fungible token (NFT) community or collection associated with the activity, a name and/or description of a non-fungible token (NFT) community or collection in common between interacting users, properties of a non-fungible token (NFT) associated with the activity, a channel name, a channel handle, etc.). For example, the user may be participating on a channel associated with a particular non-fungible token (NFT) community or collection. In this case, the context information may include the name or description of the non-fungible token (NFT) community or collection and/or user attributes (e.g., wallet address, user information (e.g., name, address, email, etc.), user handle, etc.).

Alternatively, the application (e.g., service module 132, decentralized application 148, etc.) may be mapped to a corresponding context (e.g., a non-fungible token (NFT) community or collection, etc.) indicated by an identifier as described above. The information in the request may include the identifier to indicate the context. The mapping of the identifier to a context may be stored in any suitable storage platform (e.g., database system 118, a blockchain, decentralized storage system, etc.) as described above. In this case, the identifier may be determined and provided by the application in the request, where identifier module 120 retrieves the corresponding context (e.g., a non-fungible token (NFT) community or collection, etc.) from the storage platform based on the identifier.

Once the context for the application is determined, identifier module 120 identifies one or more non-fungible tokens (NFTs) of the user corresponding to the context of the activity for use as a profile picture (PFP) for the activity at operation 515. The identifier module initially retrieves the set of non-fungible tokens (NFTs) of the user for use as profile pictures (PFPs) and the corresponding metadata. This may be accomplished by retrieving the set and metadata from a central or decentralized storage platform (e.g., a blockchain, decentralized storage, off-chain storage (e.g., a database, etc.), etc.) based on the user attributes in the context information (e.g., wallet address, user name (e.g., name, address, email, etc.), etc.). The non-fungible tokens (NFTs) of the user designated for use as a profile picture (PFP) may be identified based on an indicator as described above.

Identifier module 120 compares context and/or user attributes for the activity in the context information of the request to attributes of the metadata of the non-fungible tokens (NFTs) of the user for use as profile pictures (PFPs) to identify corresponding non-fungible tokens (NFTs) for the activity. Any quantity of matching attributes may be used to indicate that a non-fungible token (NFT) of the user corresponds to the activity. For example, the non-fungible tokens (NFTs) of the user may be compared to a social media handle of the user in a message or thread engaged by the user in the application. The social media handle may be provided in the context information of the request, where metadata of the non-fungible tokens (NFTs) of the user may indicate corresponding social media handles for which to use the non-fungible tokens (NFTs) as profile pictures (PFPs) as described above. A non-fungible token (NFT) of the user may be identified based on the metadata of the non-fungible token (NFT) indicating the social media handle of the context information.

Further, the non-fungible tokens (NFTs) of the user may be compared to a name of a channel provided by the application in the context information of the request. The channel name may be provided in the context information, where metadata of the non-fungible tokens (NFTs) of the user may indicate corresponding channels for which to use the non-fungible tokens (NFTs) as profile pictures (PFPs) as described above. A non-fungible token (NFT) of the user may be identified based on the metadata of the non-fungible token (NFT) indicating the channel name of the context information.

Moreover, the application may be associated with a specific non-fungible token (NFT) community or collection. The context information of the request may indicate the community or collection (e.g., based on a name, description, identifier, etc.). The identifier may be used in a mapping to determine the context (or indicated community or collection) as described above. Non-fungible tokens (NFTs) of the user that are a member of the indicated community or collection may be identified based on a comparison of the community or collection indicated by the context information to attributes in the metadata for the non-fungible tokens (NFTs) of the user (e.g., collection name, collection description, etc.)).

Further, attributes of another user with whom the user is engaging on the application may be used to identify non-fungible tokens (NFTs) of the user for use as profile pictures (PFPs). For example, a non-fungible token (NFT) in use by the other user (e.g., as a profile picture (PFP) in a message or thread, etc.) may correspond to a non-fungible token (NFT) community or collection indicated in the context information of the request. Non-fungible tokens (NFTs) of the user that are a member of the indicated community or collection may be identified based on a comparison of attributes of the community or collection in the context information to attributes in the metadata for the non-fungible tokens (NFTs) of the user (e.g., collection name, collection description, etc.).

Alternatively, attributes of the other user may be provided in the context information of the request (e.g., name, handle, wallet address, etc.) that may be used to retrieve non-fungible tokens (NFTs) of the other user (e.g., when the other user may not be using non-fungible tokens (NFTs) in the interaction, when the user selects the other user based on a name or handle, etc.). The non-fungible token (NFT) communities or collections associated with the non-fungible tokens (NFTs) of the other user are compared to attributes of the metadata of non-fungible tokens (NFTs) of the user (e.g., collection name, collection description, etc.) to identify non-fungible tokens (NFTs) of the user that are members of the communities or collections associated with the other user. In other words, the non-fungible tokens (NFTs) of the user may be identified based on non-fungible token (NFT) communities or collections in common with the other user.

In addition, the context information of the request may indicate properties of the digital artwork or image associated with a non-fungible token (NFT) for an activity. For example, a non-fungible token (NFT) collection or community may not be able to be determined for a non-fungible token (NFT) of the activity (e.g., a non-fungible token (NFT) of a message indicating a sending user, etc.). In this case, non-fungible tokens (NFTs) of the user that are similar to the non-fungible token (NFT) of the activity may be identified based on a comparison of attributes of the non-fungible token (NFT) in the context information to attributes of the non-fungible tokens (NFTs) of the user in the metadata for the non-fungible tokens (NFTs) of the user (e.g., properties or features of the non-fungible token (NFT), etc.)). Any quantity of matching features or properties may be used to indicate similar non-fungible tokens (NFTs).

The non-fungible tokens (NFTs) of the user may be identified based on satisfaction of one or more of the above conditions (e.g., handle, channel name, application association, common non-fungible tokens (NFTs), properties, etc.).

When non-fungible tokens (NFTs) of the user are not identified as corresponding to the context of the application as determined at operation 520, identifier module 120 selects a non-fungible token (NFT) of the user as a profile picture (PFP) for the activity at operation 530. For example, the identifier module may select a default non-fungible token (NFT) as a profile picture (PFP) for the activity. The default non-fungible token (NFT) may be pre-configured based on settings or parameters, or selected by a user when establishing the set of non-fungible tokens (NFTs) to be used as profile pictures (PFPs). An indicator may be stored to indicate the default non-fungible token (NFT).

Alternatively, identifier module 120 may prompt a user to select a non-fungible token (NFT) to use as the profile picture (PFP). In this case, the identifier module may present a list of the non-fungible tokens (NFTs) of the user on a graphical user or other interface of a client system 114 (e.g., via interface module 122). The user may enter a selection of the non-fungible token to use as a profile picture (PFP) for the application (e.g., similar to FIGS. 6 and 7 described below).

When a single non-fungible token (NFT) of the user is determined to be associated with the context of the activity as determined at operation 525, identifier module 120 provides and directs the application to use the determined non-fungible token (NFT) as a profile picture (PFP) at operation 540 as described below.

When more than one non-fungible token (NFT) of the user is identified to be associated with the context of the activity as determined at operation 525, identifier module 120 selects an identified non-fungible token (NFT) for use a profile picture (PFP) for the activity at operation 535. This may be accomplished by the identifier module based on various conditions or scenarios. For example, the identifier module may enable the user to select the identified non-fungible token (NFT) to prioritize. In this case, the identifier module may present a list of the identified non-fungible tokens (NFTs) of the user on a graphical user or other interface of a client system 114 (e.g., via interface module 122). The user may enter a selection of the identified non-fungible token (NFT) to use as a profile picture (PFP) for the application (e.g., similar to FIGS. 6 and 7 described below).

By way of further example, content identifier module 120 may randomly choose an identified non-fungible token (NFT) to use as the profile picture for the application, or select the identified non-fungible token (NFT) with a greatest monetary or other value. The random selection may utilize any conventional or other randomization technique (e.g. a random number generator, etc.) to generate a random number in a range of numbers assigned to the identified non-fungible tokens (NFTs). The generated random number indicates the particular identified non-fungible token (NFT) assigned to that number to use as the profile picture (PFP).

In addition, identifier module 120 may rotate between the identified non-fungible tokens (NFTs) on a time interval (e.g., seconds, minutes, hours, etc.). For example, the identifier module may indicate an identified non-fungible token (NFT) to use as a profile picture (PFP) from the identified non-fungible tokens (NFTs) on a round-robin basis at each time interval (e.g., at 15 seconds indicate PFP1, at next 15 seconds indicate PFP2, etc.). Accordingly, the identifier module selects the identified non-fungible token (NFT) currently being indicated at the time of the request (or determination of that non-fungible token (NFT)).

Once the non-fungible token (NFT) of the user has been determined at operations 525, 530, or 535, identifier module 120 provides the determined non-fungible token (NFT) to the application for use as a profile picture (PFP) at operation 540. The response to the request provided by the identifier module may include only the determined non-fungible token (NFT). Alternatively, the response to the request may include the determined non-fungible token (NFT) as part of a list of non-fungible tokens (NFT) provided to the application. The list includes the non-fungible tokens (NFTs) of the user designated for use as profile pictures (PFPs). In this case, the determined non-fungible token (NFT) may be at a certain position within the list (e.g., the first non-fungible token (NFT) of the list, etc.). In addition, the determined non-fungible token (NFT) may be provided in the response to the request with the list, where the determined non-fungible token (NFT) may be separated in a response payload to indicate a status as a recommended contextual non-fungible token (NFT) (e.g., a payload of {mainPFP: “PFP1”, PFPs: [“PFP2”, “PFP3”, . . . , “PFPn”]}, where “PFP1” is indicated (“mainPFP”) as the recommended non-fungible token (NFT) to use as the profile picture (PFP)).

The response to the request may include attributes of the determined non-fungible token (NFTs) (e.g., name and/or description of the non-fungible token (NFT), wallet address, user information (e.g., name, address, email, etc.), etc.), and enables or directs retrieval of the non-fungible token (NFT) (or associated digital artwork or image) from the wallet (or blockchain) for use as the profile picture (PFP).

The application (e.g., service module 132, decentralized application 148, etc.) may analyze the response from identifier module 120, and use the determined non-fungible token (NFT) of the user as a profile picture (PFP) for the activity to modify the user experience accordingly (e.g., to identify the user in communication threads or channels by the determined non-fungible token (NFT), etc.). This may be accomplished by the application using the attributes of the determined non-fungible token (NFT) in the response to retrieve the non-fungible token (NFT) (or associated digital artwork or image) from the wallet (or blockchain). The application uses the determined non-fungible token (NFT) (or associated digital artwork or image) as the profile picture (PFP) of the user for the activity. Accordingly, the response directs or enables the application to use a non-fungible token (NFT) (or associated digital artwork or image) of the user corresponding to the activity as the profile picture (PFP) for the activity.

Alternatively, identifier module 120 may use the attributes of the determined non-fungible token (NFT) to retrieve the determined non-fungible token (NFT) (or associated digital artwork or image) from the wallet (or blockchain). A copy of the digital artwork or image of the determined non-fungible token (NFT) may be provided in the response. The response directs or enables the application to use the provided non-fungible token (NFT) (or associated digital artwork or image) as the profile picture (PFP) of the user for the activity.

The non-fungible token (NFT) used as a profile picture (PFP) may be displayed with a visual indicator (e.g., box, asterisk, checkmark, etc.) to indicate the profile picture (PFP) is a non-fungible token (NFT) owned by the user. This authenticates the user identity for the activity to provide enhanced security (e.g., a message or comment posted or sent on a channel or platform can be easily and quickly verified as being from the actual user, etc.).

Further, the non-fungible token (NFT) used as a profile picture (PFP) may be used to grant or deny access to a channel, community, or application. For example, a channel or application may be associated with a non-fungible token (NFT) community or collection. The non-fungible token (NFT) used as a profile picture (PFP) can confirm ownership by the user of a non-fungible token (NFT) of the community or collection. The application may use a presence of a corresponding non-fungible token (NFT) to determine to grant or deny access to the user to the channel, community, or application (e.g., allow or prevent the user to post or send messages or comments, etc.). By way of example, when a non-fungible token (NFT) of the user is identified that corresponds to the context (e.g., channel, community, or application), the user may be granted access to the channel, community, or application to perform activities (with the identified non-fungible token (NFT) used as the profile picture (PFP)). However, when no non-fungible token (NFT) of the user is identified that corresponds to the context (e.g., channel, community, or application), the user may be denied access to the channel, community, or application.

The application providing the activity (e.g., service module 132, decentralized application 148, etc.) may alternatively determine the non-fungible token (NFT) of the user to use as a profile picture (PFP) based on a context of the activity in substantially the same manner described above (e.g., operations 510-535). Once the non-fungible token (NFT) is determined, the application is enabled or directed to use the determined non-fungible token (NFT) as the profile picture (PFP) for the user for the activity in substantially the same manner described above (e.g., for FIGS. 4 and 5).

In addition, the application (e.g., service module 132, decentralized application 148, etc.) may use registration module 116 to perform a log in for the application. In this case, the application provides a user credential (e.g., a blockchain domain name provided by the user, etc.) and the identifier. The identifier indicates the context for the application as described above. The registration module performs a lookup of the user credential to validate the user (e.g., wallet verification, identity verification, etc.). Once the user is validated, the identifier is provided to identifier module 120 to determine a non-fungible token (NFT) of the user to use as the profile picture (PFP) for the application in substantially the same manner described above. The identifier module provides the determined non-fungible token (NFT) to the registration module in substantially the same manner described above (e.g., attributes of the determined non-fungible token (NFT), a copy of the associated digital artwork or image, etc.). The registration module sends a response to the application including a validation indication and the determined non-fungible token (NFT). The application enables access to the user based on the validation, and the response enables or directs the application to use the determined non-fungible token (NFT) for user activity in substantially the same manner described above.

An example of operation of an embodiment of the present invention is illustrated in FIGS. 6, 7, and 8A-8C. Initially, a user may be a non-fungible token (NFT) collector that has several non-fungible tokens (NFT) and participates in a number of communication and/or information channels.

Conventional approaches may enable the user to select a non-fungible token (NFT) for use as a profile picture (PFP). However, the selected non-fungible token (NFT) for use as the profile picture (PFP) remains the same across all of the user channels.

With respect to an embodiment of the present invention, the user may establish the desired non-fungible tokens (NFTs) to use as profile pictures (PFPs), and associate metadata therewith as described above to enable dynamic selection of a non-fungible token (NFT) for use as a profile picture (PFP) based on a context of an activity.

For example, the user may select one or more non-fungible tokens (NFTs) from a connected wallet for use as a profile picture (PFP) as illustrated in FIGS. 6 and 7. Specifically, profile interface screen 600 (FIG. 6) shows a profile image 605 (when a default profile image has been selected), and includes an actuator 610 to enable selection of one or more non-fungible tokens (NFTs) for use as a profile picture (PFP).

When the user actuates actuator 610, a selection interface screen 700 (FIG. 7) is displayed that presents non-fungible tokens (NFTs) 705 of the user (e.g., NFT1 as viewed in FIG. 7) within the connected wallet, and an actuator 710 to enable one or more selected non-fungible tokens (NFTs) (e.g., NFT1 as shown in FIG. 7) to be used as a profile picture (PFP).

Once the non-fungible tokens (NFTs) of the user have been selected for use as a profile picture (PFP), the embodiment of the present invention enables dynamic selection of a non-fungible token (NFT) for use as a profile picture (PFP) based on a context of an activity. Accordingly, when the user is on a channel associated with a particular non-fungible token (NFT) community or collection, the non-fungible token (NFT) of the user corresponding to that community or collection is dynamically selected and used as the profile picture (PFP).

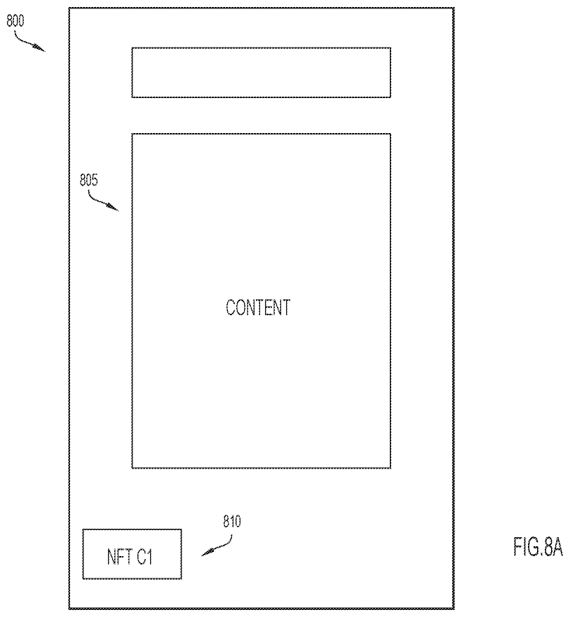

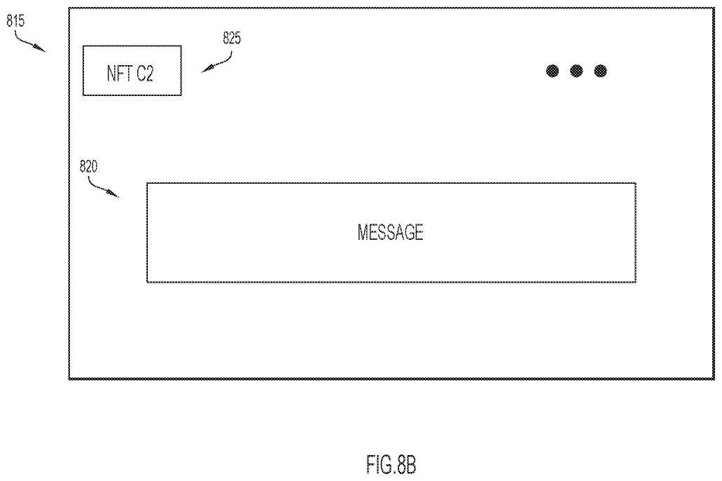

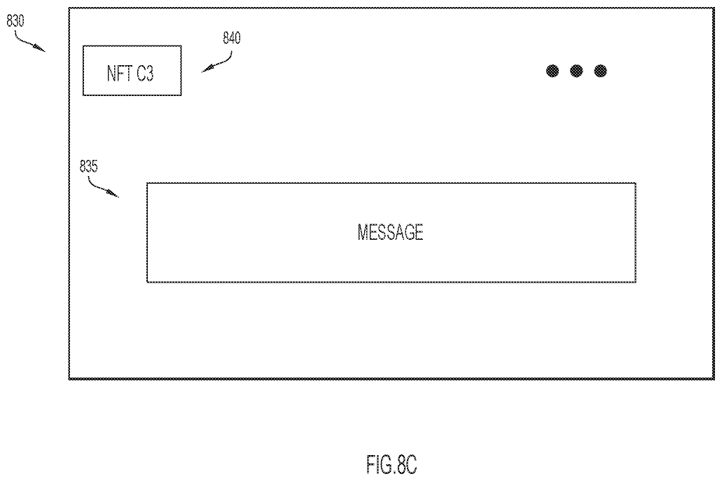

For example, the user may be on a channel provided by an application (e.g., service module 132, decentralized application 148, etc.) and associated with a first non-fungible token (NFT) collection as illustrated in FIG. 8A. Interface screen 800 includes a content area 805 for channel content, and an area 810 for a profile picture (PFP) of the user. In this case, area 810 displays the non-fungible token (NFT) of the user corresponding to the first non-fungible token (NFT) collection associated with the channel (e.g., NFT C1 as shown in FIG. 8A).

However, the user may respond to a message on a social media channel of a platform provided by the same or a different application. The channel may be associated with a second different non-fungible token (NFT) collection as illustrated in FIG. 8B. Interface screen 815 includes a message area 820 for message content, and an area 825 for a profile picture (PFP) of the user responding to the message. In this case, area 825 displays the non-fungible token (NFT) of the user corresponding to the second non-fungible token (NFT) collection associated with the channel (e.g., NFT C2 as shown in FIG. 8B).

The user may further respond to a message on the same or a different application with a social media handle associated with a third different non-fungible token (NFT) collection as illustrated in FIG. 8C. Interface screen 830 includes a message area 835 for message content, and an area 840 for a profile picture (PFP) of the user responding to the message. In this case, area 840 displays the non-fungible token (NFT) of the user corresponding to the third non-fungible token (NFT) collection associated with the handle (e.g., NFT C3 as shown in FIG. 8C).

Accordingly, present invention embodiments dynamically change the non-fungible token (NFT) of a user used for a profile picture (PFP) based on the context of an activity performed within an application. This enables the profile pictures (PFPs) of users to be dynamically switched as activities performed by the user change within and across different applications.

Present invention embodiments may provide various technical and other advantages. For example, present invention embodiments provide enhanced security for electronic communications. The non-fungible token (NFT) used as a profile picture (PFP) may be displayed with a visual indicator (e.g., box, asterisk, checkmark, etc.), thereby indicating the profile picture (PFP) is a non-fungible token (NFT) owned by the user. This immediately authenticates the user identity for the activity to provide enhanced security (e.g., a message or comment posted or sent on a channel or platform can be easily and quickly verified as being from the actual user, etc.).

Further, the non-fungible token (NFT) used as a profile picture (PFP) may be used to grant or deny access to a channel, community, or application. For example, a channel or application may be associated with a non-fungible token (NFT) community or collection. The non-fungible token (NFT) used as a profile picture (PFP) can confirm ownership by the user of a non-fungible token (NFT) of the non-fungible token (NFT) community or collection. The application may use a presence of a corresponding non-fungible token (NFT) as a profile picture (PFP) to determine to grant or deny access to the user to the channel, community, or application (e.g., allow or prevent the user to post or send messages or comments, etc.). This enables the channels, communities, and/or applications to restrict access to only those users having or owning a non-fungible token (NFT) of the community or collection. Moreover, an application may restrict access to specific channels or threads provided by the application and pertaining to non-fungible token (NFT) communities or collections based on the presence of a corresponding non-fungible token (NFT) for use as a profile picture (PFP).

In addition, present invention embodiments perform real time switching of non-fungible tokens (NFTs) as profile pictures (PFPs) based on context to provide automatic and immediate authentication of the user with respect to different channels, communities, and applications. Conventional approaches may enable the user to select a non-fungible token (NFT) for use as a profile picture (PFP). However, the selected non-fungible token (NFT) for use as the profile picture (PFP) is static and remains the same across all of the user channels or platforms. This may authenticate the user only with respect to the community or collection of the static non-fungible token (NFT). In contrast, present invention embodiments dynamically change or switch in real time a non-fungible token (NFT) used to indicate a user identity (e.g., profile picture (PFP), etc.) as a context changes within and across different channels, communities, and applications. Thus, as a user performs activities in different contexts, the corresponding non-fungible token (NFT) used as a profile picture (PFP) automatically changes or switches to another user non-fungible token (PFP) that corresponds with the different contexts. This provides automatic and immediate authentication of the user as described above with respect to the different channels, communities, and applications.

It will be appreciated that the embodiments described above and illustrated in the drawings represent only a few of the many ways of implementing embodiments for dynamic utilization of a non-fungible token (NFT) as a user identifier based on context. In addition, characteristics or features of embodiments of the present invention may be combined in any fashion to provide additional embodiments of the present invention.

The environment of the present invention embodiments may include any number of computer or other processing systems (e.g., client or end-user systems, server systems, service provider systems, blockchain systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, hand-held devices, smartphones or other mobile devices, etc.), and may include any commercially available operating system and any combination of commercially available and custom software (e.g., communications software; server software; software of present invention embodiments (including registration module 116, identifier module 120, interface module 122, service modules 132, decentralized applications (dApps) 148, etc.)). These systems may include any types of monitors and input devices (e.g., keyboard, mouse, voice recognition, etc.) to enter and/or view information.

It is to be understood that the software of the present invention embodiments (e.g., registration module 116, identifier module 120, interface module 122, service modules 132, decentralized applications (dApps) 148, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, server, service provider, and blockchain systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., registration module 116, identifier module 120, interface module 122, service modules 132, decentralized applications (dApps) 148, etc.) may be available on a non-transitory computer useable or readable medium (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium. The computer useable or readable medium (or media) may include instructions executable by one or more processors to perform functions of present invention embodiments described herein.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., mappings of applications or channels to non-fungible token (NFT) communities or collections, metadata and/or properties associated with non-fungible tokens (NFTs), etc.). The database system may be implemented by any number of any conventional or other databases, data stores or storage structures to store information. The database system may be included within or coupled to the server, client, service provider, and/or blockchain systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., determined non-fungible token (NFT) to use as a profile picture (PFP), information for selection of a non-fungible token (NFT) for use as a profile picture (PFP), etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report may include any information arranged in any fashion, and may be configurable based on rules or other criteria to provide desired information to a user (e.g., determined non-fungible token (NFT) to use as a profile picture (PFP), etc.).

The present invention embodiments are not limited to the specific tasks or algorithms described above, but may be utilized for dynamically utilizing any types of user identifiers based on a context of any activities. Accordingly, present invention embodiments may dynamically change or switch in real time any identifier used to indicate a user identity (e.g., non-fungible token (NFT), profile picture (PFP), image, symbol, etc.) as a context changes within and across applications or environments. The dynamically changed or switched identifier corresponds to the changed context. Thus, as a user performs activities in different contexts, the corresponding user identifier (e.g., profile picture (PFP), non-fungible token (NFT), etc.) automatically changes or switches to another user identifier that corresponds with the different contexts.

The present invention embodiments may process requests for non-fungible tokens (NFTs) or other assets from any entity (e.g., user, application, service, computing or other device, etc.). The non-fungible tokens (NFTs) or other assets may correspond to various items (e.g., blockchain or other domain name, digital art, music, video game items, etc.) to associate a user or other entity therewith (e.g., organization, association, company, community, etc.).

Any quantity of any attributes may be associated with a non-fungible token (NFT) or other asset. The metadata may include any information arranged in any fashion (e.g., community or collection name, community or collection description, minter or creator, keywords and/or properties, channels, platforms, handles, etc.). The metadata may be associated with a user/owner and/or any quantity of non-fungible tokens (NFTs) or other assets. The metadata may be stored on a blockchain and/or an off-chain data source. The data source may include any storage structure (e.g., decentralized storage structure or platform, blockchain storage, database, etc.).

The context may be based on any activity (e.g., engaging channels, sending messages, interacting with other users, accessing or using applications, etc.). The context may be derived from attributes of any entities (e.g., applications, users, channels, handles or other identifiers, platforms, computing or other devices, tasks being performed, non-fungible tokens (NFTs) or other assets, non-fungible token (NFT) or other asset communities or collections, etc.). For example, a context may pertain to an information or communication channel associated with the activity, a message associated with the activity, a non-fungible token (NFT) community or collection associated with the activity (or the corresponding application), a non-fungible token (NFT) community or collection in common between interacting users, etc.

The context information may include any information providing or indicating a context for the activity (or application). For example, the context information may include attributes of the user (e.g., wallet address, user information (e.g., name, address, email, etc.), user handle, etc.), attributes of another user interacting with the user (e.g., wallet address, user information (e.g., name, address, email, etc.), user handle, etc.), and attributes of a non-fungible token (NFT) associated with the activity (e.g., a name and/or description of a non-fungible token (NFT) community or collection associated with the activity, a name and/or description of a non-fungible token (NFT) community or collection in common between interacting users, properties of a non-fungible token (NFT) associated with the activity, a channel name, a channel handle, identifier of a mapping, etc.). The identifier may include any quantity of any alphanumeric or other characters to indicate a mapping between an application (or other item) and a context (e.g., non-fungible token (NFT) community or collection, context attributes, etc.).

The comparison of context attributes to attributes of the non-fungible token (NFT) metadata may use partial and/or exact matching. Further, any quantity of matching and/or partially matching attributes may be used to identify a non-fungible token (NFT) corresponding to a context of an activity (or application). The comparison of context attributes for initial and subsequent activities may use partial and/or exact matching. Further, any quantity of matching and/or partially matching attributes may be used to identify the presence or absence of a change in context. Moreover, any quantity of non-matching attributes may be used to identify the presence or absence of a change in context.

Any technique may be used to select a non-fungible token (NFT) for use as a profile picture (PFP) when no NFTs of the user are determined to correspond to a context of the activity (e.g., user selection, designated default non-fungible token (NFT), non-fungible token (NFT) with closest properties to a non-fungible token (NFT), community, or collection of the context based on a comparison of context and metadata attributes, etc.). Further, any technique may be used to select a non-fungible token (NFT) for use as a profile picture (PFP) when more than one NFT of the user are determined to correspond to a context of the activity (e.g., user selection, random selection, greatest value, round-robin selection at each of a predetermined time interval, non-fungible token (NFT) with closest properties to a non-fungible token (NFT), community, or collection of the context based on a comparison of context and metadata attributes, etc.). The time interval for the round-robin or successive selection may be any desired time interval (e.g., seconds, minutes, hours, etc.).

The non-fungible token (NFT) determined for the context may be indicated alone or with other non-fungible tokens (NFTs) of a user. A non-fungible token (NFT) determined for use as a profile picture (PFP) may be indicated from among other non-fungible tokens (NFTs) in any fashion (e.g., a certain position in a listing (e.g., first, last, intermediate position, etc.), indicator, etc.).

The non-fungible token (NFT) used as a profile picture (PFP) may be displayed with any visual or other indicator (e.g., enclosed or surrounded by a box or other shape, highlighted, underlined, bold, different color, different font, asterisk, checkmark, etc.) to indicate the profile picture (PFP) is a non-fungible token (NFT) owned by a user. Further, the non-fungible token (NFT) used as a profile picture (PFP) may be used to control (e.g., grant or deny) access to any types of entities (e.g., channel, community, application, message, thread, activity or action, etc.).

Having described preferred embodiments of a new and improved system, method, and computer program product for dynamic utilization of a non-fungible token (NFT) as a user identifier based on context, it is believed that other modifications, variations and changes will be suggested to those skilled in the art in view of the teachings set forth herein. It is therefore to be understood that all such variations, modifications and changes are believed to fall within the scope of present invention embodiments as defined by the appended claims.

What is claimed is:

1. A method of utilizing different user identifiers for performing activities of applications based on activity context comprising:
determining, via at least one processor, context information for an activity of an application performed by a user;
identifying, via the at least one processor, a non-fungible token of the user with one or more attributes corresponding to the context information; and
directing, via the at least one processor, the application to use the identified non-fungible token as a user identifier for performing the activity.

2. The method of claim 1, wherein the user identifier includes a profile picture.

3. The method of claim 1, wherein identifying the non-fungible token comprises identifying the non-fungible token based on one or more from a group of:
the non-fungible token corresponding to a non-fungible token of a message or thread engaged by the user in the application;
the non-fungible token corresponding to a non-fungible token collection associated with a name of a channel engaged by the user in the application;
the non-fungible token corresponding to a non-fungible token collection associated with the application; and
the non-fungible token corresponding to a non-fungible token of another user interacting with the user in the application.

4. The method of claim 1, wherein identifying the non-fungible token further comprises:
in response to an absence of at least one non-fungible token of the user corresponding to the context information, identifying the non-fungible token based on one from a group of a default non-fungible token and a user-selected non-fungible token.

5. The method of claim 1, further comprising:
dynamically switching, via the at least one processor, to a different non-fungible token of the user for use as the user identifier in response to a change in context of user activity, wherein the different non-fungible token corresponds to the change in context.

6. The method of claim 1, further comprising:
storing, via the at least one processor, metadata comprising a plurality of attributes for non-fungible tokens of the user, wherein the plurality of attributes indicates context for use of a corresponding non-fungible token as the user identifier and includes one or more from a group of social media platforms, websites, and handles.

7. The method of claim 1, wherein two or more non-fungible tokens of the user correspond to the context information, and identifying the non-fungible token further comprises:
identifying the non-fungible token from the two or more non-fungible tokens based on one from a group of:
user selection of a non-fungible token from the two or more non-fungible tokens;
random selection of a non-fungible token from the two or more non-fungible tokens;
selection of a non-fungible token with a greatest value from the two or more non-fungible tokens; and
rotating selection of a next non-fungible token from the two or more non-fungible tokens at each of a predetermined time interval.

8. The method of claim 7, wherein directing the application to use the identified non-fungible token as the user identifier comprises one from a group of:
providing only the identified non-fungible token to the application; and
providing a listing of the two or more non-fungible tokens to the application and indicating the identified non-fungible token within the listing.

9. A system for utilizing different user identifiers for performing activities of applications based on activity context comprising:
one or more memories; and
at least one processor coupled to the one or more memories, the at least one processor configured to:
determine context information for an activity of an application performed by a user;
identify a non-fungible token of the user with one or more attributes corresponding to the context information; and
direct the application to use the identified non-fungible token as a user identifier for performing the activity.

10. The system of claim 9, wherein the user identifier includes a profile picture.

11. The system of claim 9, wherein identifying the non-fungible token comprises identifying the non-fungible token based on one or more from a group of:
the non-fungible token corresponding to a non-fungible token of a message or thread engaged by the user in the application;
the non-fungible token corresponding to a non-fungible token collection associated with a name of a channel engaged by the user in the application;
the non-fungible token corresponding to a non-fungible token collection associated with the application; and
the non-fungible token corresponding to a non-fungible token of another user interacting with the user in the application.

12. The system of claim 9, wherein identifying the non-fungible token further comprises:
in response to an absence of at least one non-fungible token of the user corresponding to the context information, identifying the non-fungible token based on one from a group of a default non-fungible token and a user-selected non-fungible token.

13. The system of claim 9, wherein the at least one processor is further configured to:
dynamically switch to a different non-fungible token of the user for use as the user identifier in response to a change in context of user activity, wherein the different non-fungible token corresponds to the change in context.

14. The system of claim 9, wherein the at least one processor is further configured to:
store metadata comprising a plurality of attributes for non-fungible tokens of the user, wherein the plurality of attributes indicates context for use of a corresponding non-fungible token as the user identifier and includes one or more from a group of social media platforms, websites, and handles.

15. The system of claim 9, wherein two or more non-fungible tokens of the user correspond to the context information, and identifying the non-fungible token further comprises:
identifying the non-fungible token from the two or more non-fungible tokens based on one from a group of:
user selection of a non-fungible token from the two or more non-fungible tokens;
random selection of a non-fungible token from the two or more non-fungible tokens;
selection of a non-fungible token with a greatest value from the two or more non-fungible tokens; and
rotating selection of a next non-fungible token from the two or more non-fungible tokens at each of a predetermined time interval.

16. The system of claim 15, wherein directing the application to use the identified non-fungible token as the user identifier comprises one from a group of:
providing only the identified non-fungible token to the application; and
providing a listing of the two or more non-fungible tokens to the application and indicating the identified non-fungible token within the listing.

17. A computer program product for utilizing different user identifiers for performing activities of applications based on activity context, the computer program product comprising one or more computer readable media having instructions stored thereon, the instructions executable by at least one processor to cause the at least one processor to:
determine context information for an activity of an application performed by a user;
identify a non-fungible token of the user with one or more attributes corresponding to the context information; and
direct the application to use the identified non-fungible token as a user identifier for performing the activity.

18. The computer program product of claim 17, wherein the user identifier includes a profile picture.

19. The computer program product of claim 17, wherein identifying the non-fungible token comprises identifying the non-fungible token based on one or more from a group of:
the non-fungible token corresponding to a non-fungible token of a message or thread engaged by the user in the application;
the non-fungible token corresponding to a non-fungible token collection associated with a name of a channel engaged by the user in the application;
the non-fungible token corresponding to a non-fungible token collection associated with the application; and
the non-fungible token corresponding to a non-fungible token of another user interacting with the user in the application.

20. The computer program product of claim 17, wherein identifying the non-fungible token further comprises:
in response to an absence of at least one non-fungible token of the user corresponding to the context information, identifying the non-fungible token based on one from a group of a default non-fungible token and a user-selected non-fungible token.

21. The computer program product of claim 17, wherein the instructions executable by the at least one processor further cause the at least one processor to:
dynamically switch to a different non-fungible token of the user for use as the user identifier in response to a change in context of user activity, wherein the different non-fungible token corresponds to the change in context.

22. The computer program product of claim 17, wherein the instructions executable by the at least one processor cause the at least one processor to:
store metadata comprising a plurality of attributes for non-fungible tokens of the user, wherein the plurality of attributes indicates context for use of a corresponding non-fungible token as the user identifier and includes one or more from a group of social media platforms, websites, and handles.

23. The computer program product of claim 17, wherein two or more non-fungible tokens of the user correspond to the context information, and identifying the non-fungible token further comprises:
identifying the non-fungible token from the two or more non-fungible tokens based on one from a group of:
user selection of a non-fungible token from the two or more non-fungible tokens;
random selection of a non-fungible token from the two or more non-fungible tokens;
selection of a non-fungible token with a greatest value from the two or more non-fungible tokens; and
rotating selection of a next non-fungible token from the two or more non-fungible tokens at each of a predetermined time interval.

24. The computer program product of claim 23, wherein directing the application to use the identified non-fungible token as a user identifier comprises one from a group of:
providing only the identified non-fungible token to the application; and
providing a listing of the two or more non-fungible tokens to the application and indicating the identified non-fungible token within the listing.
